(19) United States
(12) Patent Application Publication
(10) Pub. No.: US 2019/0352942 A1
(43) Pub. Date: Nov. 21, 2019

(54) HANDLE COMPRISING A SECURING ELEMENT

(71) Applicant: Huf Hülsbeck & Fürst GmbH & Co. KG, Velbert (DE)

(72) Inventors: Willi Put, Winterswijk Meddo (NL); Marion Kilian, Velbert (DE); Oleg Dornhof, Neuss (DE)

(21) Appl. No.: 16/484,126

(22) PCT Filed: Feb. 19, 2018
(86) PCT No.: PCT/EP2018/053980

§ 371 Date: Aug. 7, 2019

(30) Foreign Application Priority Data
Feb. 24, 2017 (DE) 10 2017 103 961.9

(51) Int. Cl. E05B 79/06; E05B 85/16

(52) U.S. Cl. CPC E05B 79/06; E05B 85/16

(57) ABSTRACT

A handle for a motor vehicle includes a mounting carrier which can be secured on the inside of a door of the motor vehicle, and a grip level that can be arranged on the outside of the door of the motor vehicle and is secured to said mounting carrier. The mounting carrier comprises a control element that is operatively connected to a securing element which can be arranged on the outside of the door. The control element is movable from a retaining position into a securing position as the result of which the distance between the securing element and the control element can be reduced, thus allowing the mounting carrier to be fastened to the door in a reliable manner.

### CROSS REFERENCE TO RELATED APPLICATIONS

This application claims priority under 35 U.S.C. § 371 to Patent Cooperation Treaty Application No. PCT/EP2018/053980, filed Feb. 19, 2018, which claims priority to DE Application No. 102017103961.9, filed Feb. 24, 2017, the contents of which are incorporated herein by reference in their entireties.

### FIELD

The present invention relates to a handle for a motor vehicle. Furthermore, the invention relates to a method for mounting said handle.

### BACKGROUND

This section provides background information related to the present disclosure and is not necessarily prior art.

It is known from the prior art to mount handles of a motor vehicle with a mounting carrier which is fastened on the inside of a motor vehicle door, and a grip lever, which is arranged on the outside of the door. It has been shown disadvantageously that there are always mounting delays and mounting inaccuracies. Among other things, it is because some components of the handle are difficult to mount due to their geometry, especially as the space conditions often complicate this.

It is therefore an object of the present invention to at least partially overcome the disadvantages described above.

### SUMMARY

This section provides a general summary of the disclosure, and is not a comprehensive disclosure of its full scope or all its features.

One aspect of the disclosure provides a handle and another aspect provides a method. Further features and details of the invention will become apparent from the claims, the description and the drawings. Thereby, features and details that are described in connection with the handle according to the invention, of course also apply in connection with the method according to the invention, and respectively vice versa, so that, with respect to the disclosure of individual aspects of the invention, alternate reference is always or can be made.

The object is achieved in particular by a handle for a motor vehicle, with a mounting carrier which can be fastened on the inside of a door of the motor vehicle, a grip lever, which can be arranged on the outside of the door of the motor vehicle and can be fastened to the mounting carrier. Here it is provided in particular that the mounting carrier has a control element which is operatively connected to a securing element which can be arranged on the outside of the door, wherein the control element can be moved from a retaining position into a securing position, whereby the distance between the securing element and the control element can be reduced, so that a reliable fixation of the mounting carrier on the door can be achieved. Advantageously, the fastening effort of the handle on the motor vehicle door can hereby be simplified and facilitated for the operator. By reducing the distance between the securing element arranged on the outside of the door and the control element arranged on the inside, there is an increased force exerted on the mounting carrier so that it is pressed to the inside of the door with an increased force. The securing element tightly abuts the outside of the door after mounting, whereby a sealing effect is additionally achieved by the securing element. The introduction of the force into the securing element takes place via the movement of the control element.

According to a further possibility, it can be provided that the securing element has a locking means, which, in the securing position, extends into a counter locking means of the control element. Advantageously, by means of the counter locking means of the control element, a reliable hold of the securing element is effected on the outside of the door.

This construction serves as burglary protection. Advantageously, the locking means is correspondingly adapted to the geometry of the counter locking means. In the retaining position of the control element, the locking means is advantageously detached from the counter locking means.

A further advantage can be achieved within the context of the invention if the securing element has a fastening region which acts on the mounting carrier. For example, the fastening region can be fixed on the mounting carrier in a positive and/or non-positive manner to a defined position. It is conceivable that fixation of the fastening region on the mounting carrier can be achieved via a latching connection.

Furthermore, it can be provided within the context of the invention that during a movement of the control element from the retaining position into the securing position, the securing element is pivotable about a rotation axis, in particular that the rotation axis passes through the fastening region. The fastening region may be a fixed bearing of the securing element, wherein the securing element is rotatable only at the fastening region. The locking means may for example be positioned on the opposite side of the securing element, wherein, during the distance reduction of the securing element to the control element, the locking means also pivots about the rotation axis of the fastening area, but also exerts a kind of lifting movement in the direction of the control element. Advantageously, the locking means performs a travel path which is less than 5 mm, advantageously less than 1.5 mm. A compact handle can be provided hereby, which can be reliably fastened to the motor vehicle door.

For example, it may be provided that the securing element has a seal on the side facing the control element. The seal may be integrated on the securing element, for example be molded. The seal is preferably designed in a flexible manner. In order to effect an increased safety of the handle, the securing element is made of metal, in particular of a steel.

Further, it is conceivable that the locking means of the securing element has at least one active surface which, upon the movement of the control element into the securing position, engages a counter active surface of the control element, so that the locking means is pulled to the counter locking means of the control element. While the control element executes the movement in the direction of the securing position, the active surface cooperates with the counter active surface, whereby a tensile force is released to the locking means. Hereby, the securing element approaches the door on the outside more and tensions therewith, at the same time the mounting carrier is pressed even more strongly to the inside door thereby.

Optionally, it can be provided that the control element has an actuator, wherein, upon actuation of the actuator, a movement of the control element is effected from the retaining position into the securing position and/or vice versa. In a further possibility, it may be provided that the actuator is located at least partially outside the mounting carrier. It has been shown to be advantageous that a comfortable mounting situation is created for the operator by the position of the actuator on the outside of the mounting carrier. The actuator is easily accessible to the operator to trigger movement of the control element in the direction of the safety position. It may be possible that the actuator is manually operated.

A further advantage can be achieved within the context of the invention if the actuator is a screw element which acts on the mounting carrier and on the control element. Advantageously, this type of actuator represents a cost-effective construction to effectively realize the movement kinematics of the control element.

Optionally, it is conceivable that the mounting carrier is designed with a cavity in which the control element is inserted, wherein the cavity is designed so that the control element is movable within the cavity between the retaining position and the securing position. The cavity is advantageously adapted to the geometry of the control element. Furthermore, the size of the cavity is designed in such a manner that the control element can reach the retaining position and the securing position, wherein the cavity provides a corresponding guidance.

Furthermore, it can be provided in the context of the invention that the control element has a rib on at least one of its sides, whereby a reliable guidance is effected during the movement of the control element on the mounting carrier. The rib may be designed as a projection and have a longitudinal extent in the direction of the movement of the control element. Advantageously, the control element forms a unitary, monolithic component with the rib. The rib slides on a wall of the cavity during the movement between the securing position and the mounting position. As a result, it is effectively prevented that a tilting or oblique position of the control element can occur during the movement of the control element.

Furthermore, it may be provided in the context of the invention that the control element is arranged within the mounting carrier in such a manner that the control element is linearly movable between the retaining position and the securing position. The linear movement of the control element favors a compact overall construction of the handle.

As a further advantage it can be provided that a movable activation element is arranged on the mounting carrier, wherein in the retaining position, the control element engages the activation element, whereby the activation element is held in a mounting position, in order to enable a simplified mounting of the grip lever, in which the securing position is detached from the activation element. By means of a movement of the activation element, a closing system on the motor vehicle side can be activated; in particular, a closing signal or an opening signal can be triggered hereby in order, for example, to open a motor vehicle door. A movement of the mentioned activation element takes place via a manual operation of the grip lever on the outside. If the control element is in the retaining position, sufficient mounting space is created in order to fasten the grip lever reliably and without collisions with other components on the activating element.

For example, it may be provided that the control element has a retaining region which engages in the retaining position of the control element on a contact surface of the activation element. The retaining region may be arranged projecting on the control element to effectively engage the contact surface of the activation element when the control is in the retaining position.

Furthermore, it is conceivable that the handle has a dome which is held in a fastening zone of the activation element. Advantageously, the activation element is rotatably mounted about an axis on the mounting carrier, wherein it can assume a mounting position, in which the control element engages the contact surface with its retaining region. After the control has left the retaining position, the activation element can pivot into its operating position. Hereby, the grip lever located on the outside side of the door is correspondingly brought to its rest position. The dome extends through an opening of the door and may be correspondingly designed geometrically to achieve a corresponding hold in the fastening zone of the activation element.

In addition, it is conceivable within the context of the invention that the fastening region is in contact with the dome. Hereby, a reliable fastening and/or storage of the handle on the door can be ensured.

It can be provided that a closing cylinder unit is movably mounted on the mounting carrier, whereby the closing cylinder unit can be brought between a pre-mounting position and a final mounting position, wherein in particular the closing cylinder unit is rotatably mounted about an axis. The closing cylinder unit can be provided in order to trigger a corresponding action for the closing system on the vehicle side. For example, the mentioned action can be triggered via a key that is inserted into the closing cylinder unit. In a further possibility, it may be provided that in the retaining position of the control element, the closing cylinder unit is in the pre-mounting position and, in the securing position of the control element, the closing cylinder unit is in the final mounting position. To increase the ease of mounting, the closing cylinder unit is in a pre-mounting position in order to fasten the grip lever, in particular the dome, to the activation element. A mounting margin is created in addition hereby, in order to fasten the grip lever to the mounting carrier in a collision-free manner.

Furthermore, it may be provided that the closing cylinder unit has a control geometry, which is engaged by the control element, in particular that the control element has a connecting element which is in operative connection with the control geometry. This embodiment favors a well-functioning motion kinematics for the closing cylinder unit and for the control element. The connecting element may for example be designed as a projection or as a reception, wherein the connecting element is guided through the control geometry. The control geometry can be at least partially curved, with for example also linear portions. Such control geometries favor a linear movement of the control element or a rotational movement of the closing cylinder unit about an axis.

In a further possibility, it can be provided that the control element has a reception in which the closing cylinder unit is arranged, in particular that the closing cylinder unit is partially enclosed by the control element. An effective protection of the closing cylinder unit can be achieved within the control element hereby. At the same time, a well-functioning mounting of the closing cylinder unit can be effected, as the closing cylinder unit is effectively surrounded geometrically by the control element, wherein the control element offers at least one or more bearing points for the closing cylinder unit.

It may be possible for the control to have two securing sides and one actuation side, wherein the actuation side connects both opposing securing sides and the closing cylinder unit is arranged between both securing sides. Advantageously, the securing sides are formed larger in their elongated extent than the actuation side. Advantageously, at least one securing side has the mentioned rib for improved guidance within the cavity. The actuation side further comprises the mentioned actuator, which can trigger a movement of the control element from the retaining position into the securing position and vice versa.

A further advantage within the context of the invention can be achieved if the control element has a reception region and the closing cylinder unit has an axle body through which the axle passes, wherein the axle body moves relatively within the reception region in particular upon the movement of the control element. The reception region can provide a reliable bearing location for the closing cylinder unit, at which the axle body can pivot about its axis, wherein, upon movement of the control element, the axle body moves relatively within this reception region at the same time.

According to a further advantage, it can be provided that the reception region has an inner region and an edge region, wherein the reception region is designed as an opening, which becomes smaller from the inner region to the edge region, wherein, in the retaining position of the control element, the axle body is located in the inner region, and in the securing position of the control element, the axle body is located in the edge region. When the axle body is located in the edge region of the reception region, the lateral surface of the axle body is located close to the wall of the reception region. Advantageously, it may be possible that the lateral surface presses the edge region slightly apart, whereby a reliable fit of axle body is achieved within the reception region of the control element.

Advantageously, it can be provided in the context of the invention that the axle body is designed like a cylinder, wherein the lateral surface of the axle body at least partially has at least one level surface which contacts the wall of the reception region in the securing position of the control element. The cylinder-like execution of the axle body favors the kinematics of a rotation of the closing cylinder unit from the pre-mounting position to the final mounting position and vice versa. The at least one level surface on the axle body locks the position of the axle body, when this is in the final mounting position. Advantageously, the axle body has two level surfaces, which are for example aligned opposite each other, wherein each level surface rests on a level wall of the control element.

In addition, it is advantageous if, in the context of the invention, the closing cylinder unit has at least one latching element which engages a counter latching element of the control element in the securing position of the control element, wherein, in the retaining position of the control element, the latching element is detached from the counter latching element, wherein in particular the latching element and/or the counter-latching element is/are formed rib-like. The latching element of the closing cylinder unit is geometrically adapted to the counter latching element of the control element. Thus, the control element secures the position of the closing cylinder unit in its final mounting position.

According to a further possibility, it may be provided that the securing element has an opening for access to the closing cylinder unit, wherein in particular the control element is metallic. For example, the securing element may be made of a steel. The control element may be made of a die-cast zinc material. The material of the control element can be composed of the initials of the alloy components zinc and/or aluminum and/or magnesium and/or copper. This allows an increased hardness of the control element material to be achieved.

It is also advantageous if the securing element is formed in a closed manner, wherein in particular the control is made of a plastic. In this exemplary embodiment, the handle is advantageously designed without a closing cylinder. The securing element serves as a securing protection, so that no environmental pollution, such as dirt, moisture, etc. can penetrate into the interior of the door in the direction of the mounting carrier. The control element is advantageously made of a material-reinforced plastic.

The object of the invention is also a method for mounting a handle for a motor vehicle, in particular a handle according to the invention, which has already been described in detail, with a mounting carrier which can be fastened on the inside of a door of the motor vehicle, a grip lever, which can be arranged on the outside of the door of the motor vehicle and is fastened to the mounting carrier. Here it is provided that the mounting carrier has a control element which is operatively connected to a securing element which can be arranged on the outside of the door, wherein, upon movement of the control element from a retaining position into a securing position, the distance between the securing element and the control element is reduced, so that a reliable fixation of the mounting carrier on the door can be achieved. The method according to the invention thereby brings about the same advantages as described in detail with reference to the handle according to the invention.

It is conceivable that a closing cylinder unit is in operative connection with the control element, wherein, upon movement of the control element into the securing position, the closing cylinder unit moves from a pre-mounting position to a final mounting position. Hereby, the operator can be provided with sufficient mounting margin to fasten the handle to the mounting carrier.

Furthermore, it can be provided within the context of the invention that the mounting carrier has an activation element which is movably arranged on the mounting carrier, wherein, in the retaining position, the control element engages the activation element, whereby the activation element is held in a mounting position, in order to enable a simplified mounting of the grip lever on the activation element, the control element detaches from the activation element via a movement of the control element and at the same time an increased force is exerted on the mounting carrier, so that the fastening effect of the mounting carrier to the inside of the door can be increased. By means of the securing element, a corresponding force is exerted on the mounting carrier, which rests in the mounted position on the inside of the door with a sufficiently large force. At the same time, the securing element lies tightly on the outside of the door.

The control element according to the invention thus exerts a force on both mentioned components via its movement from the retaining position to the securing position, whereby the handle is held reliably on the door. The travel path of the control element can be easily realized by the operator via an actuator accessible outside the mounting carrier.

Further advantages, features and details of the invention will become apparent from the following description in which exemplary embodiments of the invention are described in detail with reference to the drawings. The features mentioned in the claims and in the description may thereby be essential to the invention individually or in any desired combination.

### DRAWINGS

The figures show:

FIG. 1 illustrates a schematic view of a handle for a motor vehicle according to the invention;

FIG. 2 illustrates a view of a mounting carrier with a control element, which is in a securing position;

FIG. 3 illustrates a further view of the mounting carrier, wherein the control element is in a retaining position, which differs from the securing position;

FIG. 4 illustrates a further view of the control element according to FIG. 3;

FIG. 5 illustrates a further perspective view of the control element according to FIG. 3;

FIG. 6 illustrates a further view of the control element according to FIG. 3;

FIG. 7 illustrates a further view of the control element, wherein the control element is in its securing position;

FIG. 8 illustrates a further view of the control element, at which a securing element is arranged, wherein the control element is in the retaining position;

FIG. 9 illustrates a further view of the control element, which takes up the securing position;

FIG. 10 illustrates a further view of the control element, at which the securing element is arranged, wherein the control element is in the retaining position;

FIG. 11 illustrates the control element in its securing position;

FIG. 12 illustrates the control element, which is engaged in the closing cylinder unit.

In the following figures, the same reference numerals are used for the same technical features also of different exemplary embodiments.

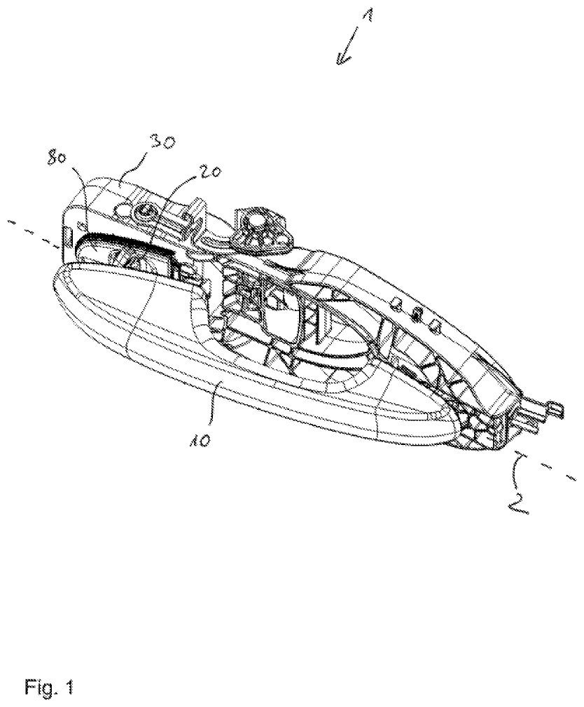

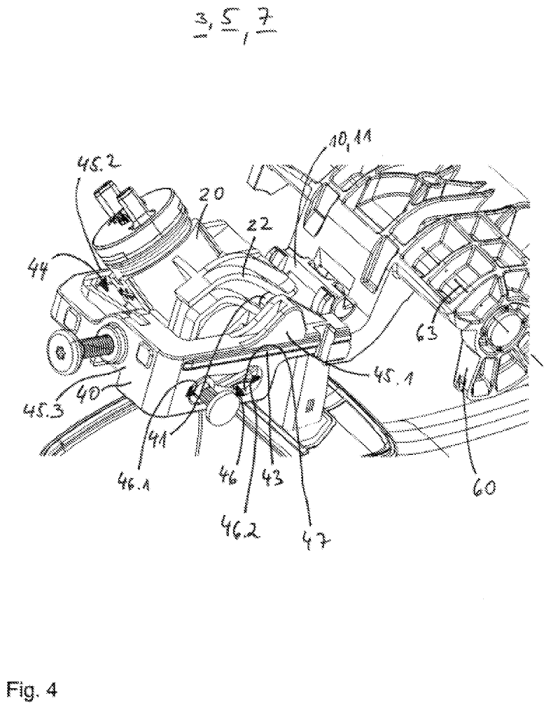

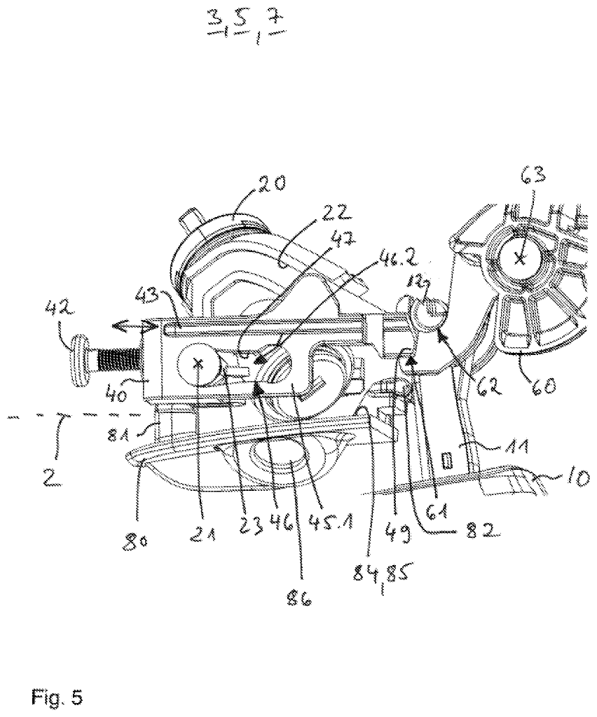

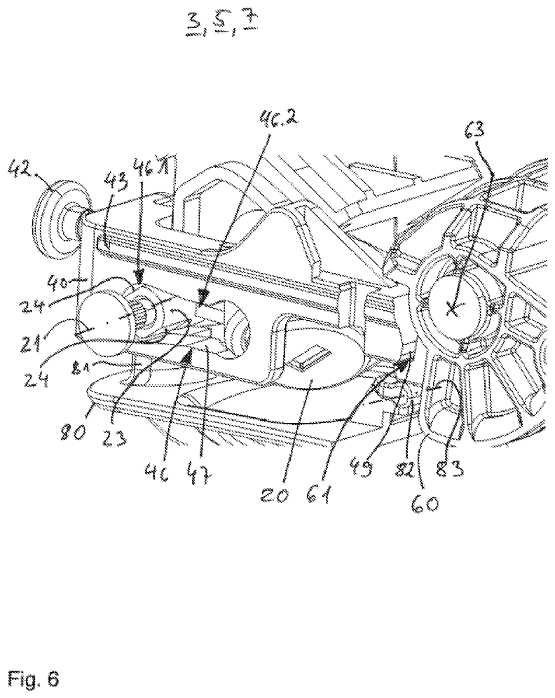

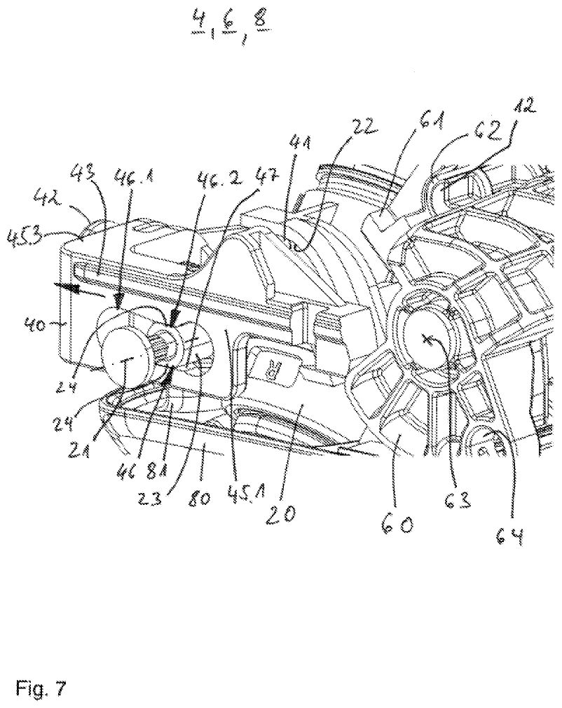

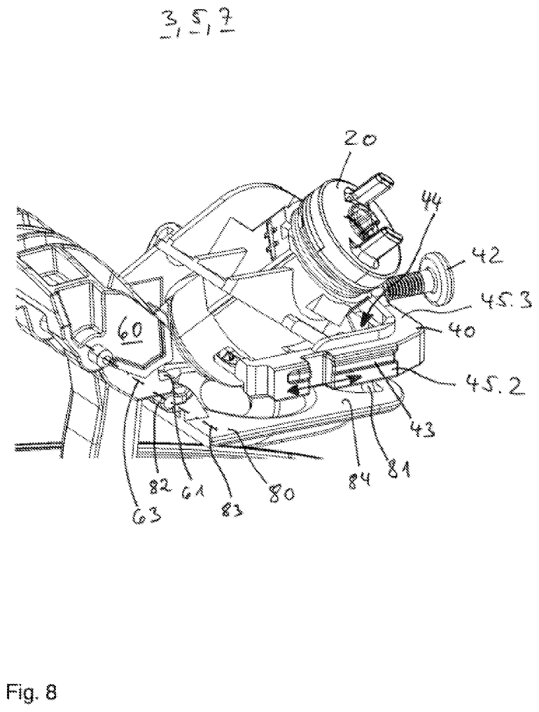

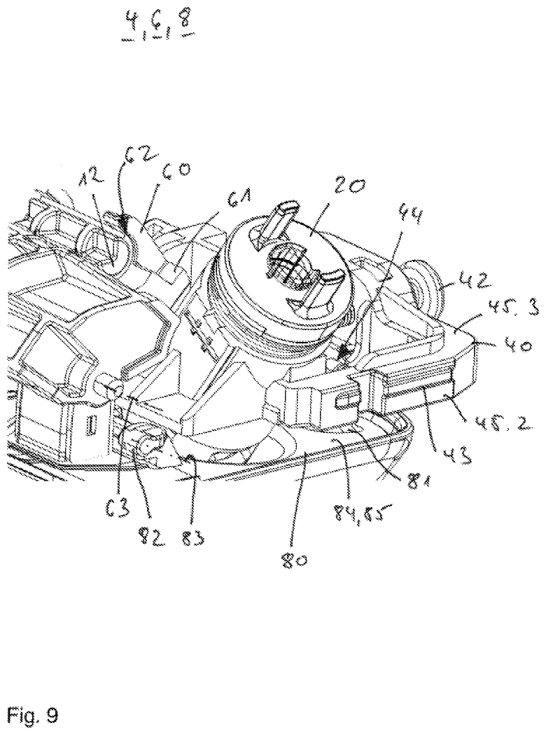

FIGS. 1 to 12 shows an exemplary embodiment of a handle 1 according to the invention, which can be fastened to a door 2 of a motor vehicle. The handle 1 has a mounting carrier 30, which is fastened on the inside of the door 2. On the outside of the door 2, the handle 1 has a grip lever 10, which is to be actuated by the operator, in particular can be pulled, wherein according to FIG. 1 the grip lever 10 is a pulling grip lever. The grip lever 10 is rotatably mounted on the mounting carrier 30 on its right side, which is not shown explicitly. On its left side, the grip lever 10 has a dome 11, which is shown for example in FIG. 5, so that by a pulling action of the user, the dome 11 initiates an action of a defined kinematics within the mounting carrier 30. According to the exemplary embodiment, the grip lever 10 is in operative connection with an activation element 60, which means that a release for a closing system within the motor vehicle can be triggered by a movement of the activation element 60. For example, it is conceivable that an opening process and/or closing process of a door 2, etc. can be effected via a movement of the activation element 60. In the present exemplary embodiment, the activation element 60 is rotatably mounted on the mounting carrier 30 about an axis 63. The activation element 60 has a fastening zone 62, in which a free end 12 of the dome 11 is held reliably. The activation element 60 additionally has a fastening reception 64, which is shown for example in FIG. 7, in which, for example, a Bowden cable can be fastened. By means of a corresponding movement of the activation element 60, the Bowden cable can be pulled, whereby a mechanical release action is started.

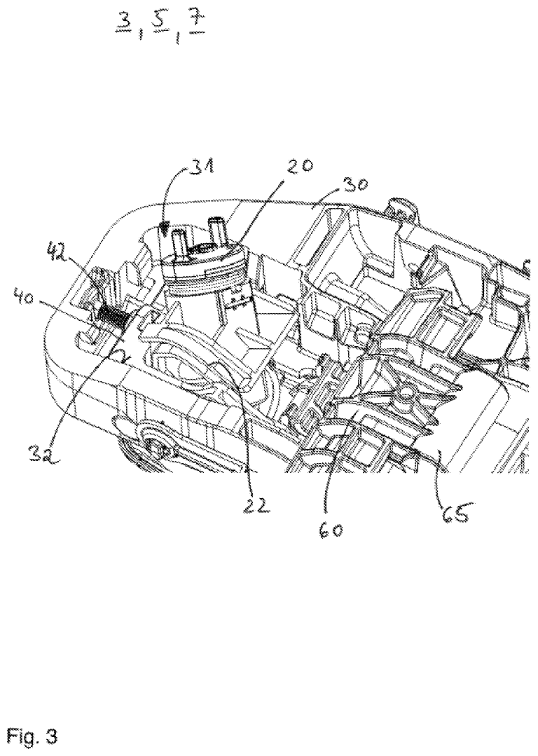

In addition, it is conceivable that the activation element 60 has a mass balance 65, which is shown in FIG. 3. The mass balance 65 serves to prevent the door handle 10 from moving out of the door 2 via the acceleration forces in the event of a crash.

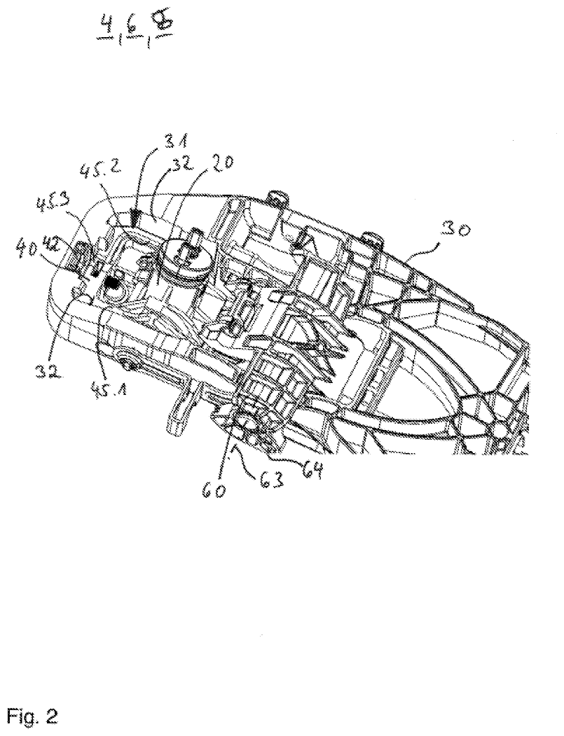

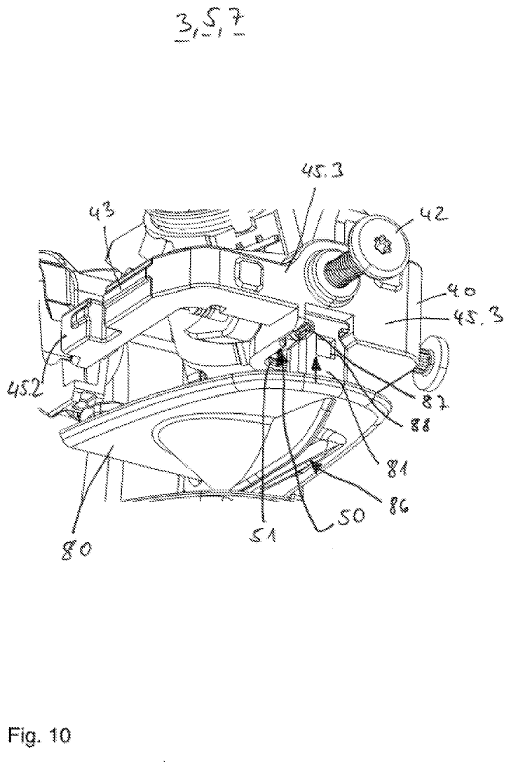

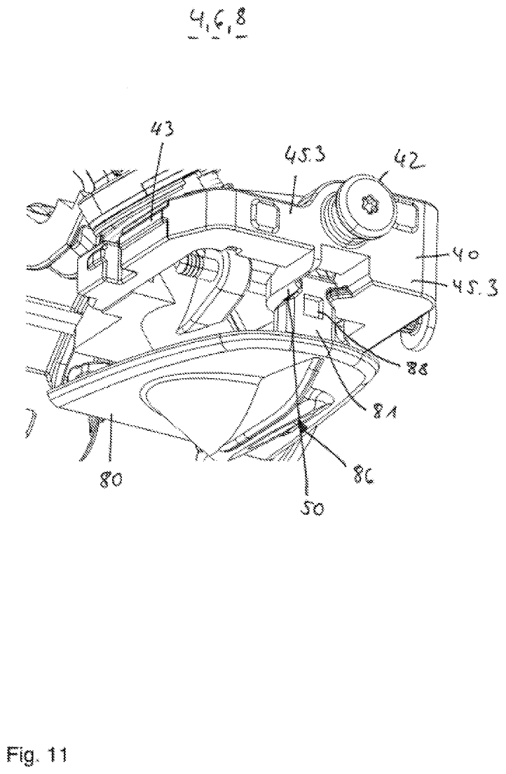

According to the exemplary embodiment according to FIG. 1 to FIG. 12, it is shown that the handle 1 has a control element 40, which is in operatively connected to a securing element 80 arranged on the outside of the door 2. The control element 40 can be moved from a retaining position 5, which is shown in FIGS. 3 to 6, FIGS. 8 and 10, to a securing position 6, which is shown in FIGS. 2, 7, 9 and 11. The control element 40 has different functions hereby, which are described below. By means of a movement of the control element 40 from the retaining position 5 to the securing position 6, the distance between the securing element 80 and the control element 40 is reduced, which is particularly illustrated in FIGS. 10 and 11. Here, the securing element 80 has a locking means 81, which engages a counter locking means 50 of the control element 40.

According to the other figures, it can be seen that the securing element 80 has, on the side opposite the locking means 81, a fastening region 82 which is arranged on the mounting carrier 30. During the movement of the control element 40 from the retaining position 5 into the securing position 6, the securing element 80 pivots about a rotation axis 83, wherein the rotation axis 83 passes through the fastening region 82. Starting with FIG. 5, a linear movement of the control element 40 to the left (see double arrow) takes place, wherein, at the same time, the securing element 80 is pivoted clockwise about the rotation axis 83, which passes through the fastening region 82. Hereby, the securing element 80 with its locking means 81 carries out a certain lifting movement in the direction of the control element 40, which is less than 2 mm. Advantageously, the securing element 80 has a seal 85 on the side 84 facing the control element 40, which is not explicitly shown.

In order for the securing element 80 to be moved in the direction of the door 2 via a movement of the control element 40 in the direction of the securing position 6, the locking means 81 of the securing element 80 has active surfaces 87 which engage counter active surfaces 51 of the control element 40 during the movement of the control element 40 into the securing position 6. The active surfaces 87 and the counter active surfaces 51 are aligned with each other in such a manner that the locking means 81 is pulled to the counter locking means 50 when the control element 40 is moved in the direction of the securing position 6. The arrow in FIG. 10, which is directed upward, shows the lifting movement of the securing element 80 which is rotatably mounted on the opposite side of the rotation axis 83.

The control element 40 has an actuator 42, wherein upon actuation of the actuator 42, the movement of the control element 40 from the retaining position 5 into the securing position 6 and/or vice versa can be triggered. Hereby, the actuator 42 is arranged on the outside of the mounting carrier 30, so that the actuator 42 can be easily operated by the operator. Hereby, the actuator 42, which is a screw member, can be operated manually. The actuator 42 acts both on the mounting carrier 30 and on the control element 40.

The mounting carrier 30 has a cavity 31, in which the control element 40 is inserted in a movable manner. The control element 40 further respectively has, on its securing sides 45.1, 45.2, a rib 43, which serves as a guide during the movement of the control element 40 on the mounting carrier 30. The securing side 45.1 is opposite the securing side 45.2. While the control element 40 is being moved, the ribs 43 slide on the wall 32 of the cavity 31.

In the retaining position 5 of the control element 40, the control element 40 engages the activation element 60, whereby the activation element 60 is obtained in a mounting position 7. A simplified mounting of the grip lever 10 on the activation element 60 is effected hereby.

The control element 40 has a retaining region 49, which engages a contact surface 61 of the activation element 60 in the retaining position 5 of the control element 40.

FIG. 5 further shows that the dome 11 of the grip lever 10 is in contact with the fastening region 82 of the securing element 80. In addition, the exemplary embodiment shows that the handle 1 can be designed with a closing cylinder unit 20. It should be noted, however, that all embodiments of the exemplary embodiment can also refer to a handle 1 that does not require a closing cylinder unit 20. In the present exemplary embodiment, the handle 1 as mentioned shows a closing cylinder unit 20 which is movably mounted on the mounting carrier 30. Hereby, the closing cylinder unit 20 can be brought between a pre-mounting position 3 and a final mounting position 4, wherein the closing cylinder unit 20 is mounted rotatably about an axis 21. In the retaining position 5 of the control element 40, the closing cylinder unit 20 is in its pre-mounting position 3. In the securing position 6 of the control element 40, however, the closing cylinder unit 20 is in its final mounting position 4. In the final mounting position 4, the closing cylinder unit 20 is accessible via a key from the user. If the grip lever 10 is not actuated on the door 2, the grip lever 10 completely covers the head region of the closing cylinder unit 20.

The closing cylinder unit 20 has a control geometry 22, which the control element 40 engages. Hereby, the control element 40 has a connecting element 41, which is formed like a projection and which is in operative connection with the control geometry 22. Hereby, the control geometry 22 is designed at least partially in a curved manner, whereby a rotational movement is about the axis 21 is favored.

The control element 40 has a reception 44, in which the closing cylinder unit 20 is arranged. The closing cylinder unit 20 is thus partially enclosed by the control element 40. In the present exemplary embodiment, the control element 40 has two securing sides 45.1, 45.2 and an actuation side 45.3. The actuation side 45.3 connects both opposing securing sides 45.1, 45.2. The closing cylinder unit 20 is hereby located between the securing sides 45.1, 45.2. The actuator 42 is located in the actuation side 45.3.

The control element 40 has a reception region 46 and the closing cylinder unit 20 has an axle body 23, wherein the axle 21 passes through the axle body 23. The axle body 23 is arranged in the reception region 46, wherein, during the movement of the control element 40, the axle body 23 moves within the reception region 46.

According to FIGS. 5, 6, 7, the reception region 46 has an inner region 46.1 and an edge region 46.2. The reception region 46 is designed as an opening, so that the axle body 23 can be mounted easily. In the retaining position 5 of the control element 50, the axle body 23 is located in the inner left region 46.1 of the reception region 46. In the securing position 6 of the control element 40, the axle body 23 is located at the edge region 46.2, which is shown in FIG. 7. The axle body 23 is designed like a cylinder, wherein the axle body 23 has two level surfaces 24 on its lateral surface. In the securing position 6 of the control element 40, the level surfaces 24 abut against level walls 47 of the reception region 46, whereby a locking action of the closing cylinder unit 20 on the control element 40 is effected.

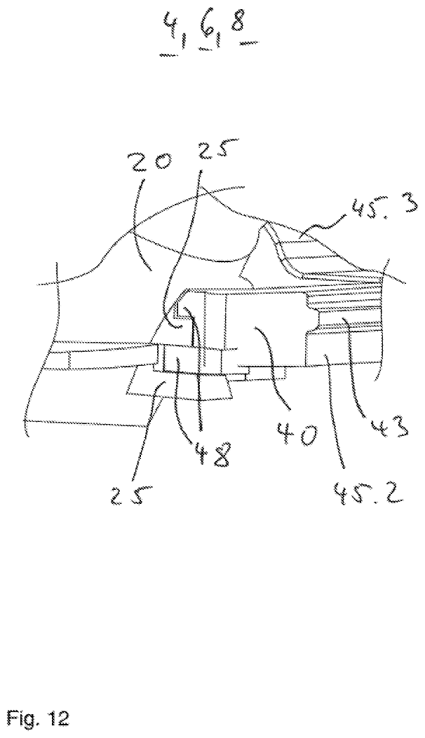

The closing cylinder unit 20 can also have a latching element 25, which, in the securing position 6 of the control element 40, engages a counter latching element 48 of the control element 40, which is shown schematically in FIG. 12. In the retaining position 5 of the control element 40, however, the latching element 25 is released from the counter-latching element 48, which is not explicitly shown. In the following exemplary embodiment, the latching element 25 and the counter-latching element 48 is formed like a rib.

The securing element 80 has an opening 86 for access to the closing cylinder unit 20. The control element 40 is preferably made metallic for safety reasons. The securing element 80 can may be made of a steel material. In a further alternative not explicitly shown, it is conceivable that the securing element 80 is designed to be closed. In this embodiment, the handle 1 is formed without the closing cylinder unit 20. Here, the control 40 may be made of a plastic.

The handle 1 according to the invention is characterized in particular by the fact that the mounting method for fastening the handle 1 to a motor vehicle is substantially simplified. First, the mounting carrier 30 is fastened to the control element 40 on the inside of the door 2. Here it is conceivable that a closing cylinder unit 20 is integrated or the mounting support 30 does not require a closing cylinder unit 20. Subsequently, the securing element 80 is fixed from the outside of the door 2, wherein, also from the outside, the grip lever 10 with its dome 11 is also guided to the door 2 or fastened there. Here, the dome 11 is guided in the direction of the mounting carrier 30, wherein the activation element 60 is in the mounting position 7. In the mounting position 7, it is effected that the control element 40 holds the activation element 60 in the mounting position 7. If the dome 11 is arranged on the activation element 60, the operator can act on the actuator 42 or rotate, so that a movement of the control element 40 in the direction of securing position 4 is initiated. The activation element 60 loses contact with the control element 40, so that the activation element 60 automatically leaves the mounting position 7 in the direction of the operating position 8. Via the movement of the control element 40 in the direction of the securing position 6, a force input into the securing element 80 takes place, which is pulled about its rotation axis 83 in the direction of the control element 40. At the same time a force is exerted on the mounting carrier 30, which presses on the inside of the door 2 as a result thereof. An effective tension of the handle 1 with the door 2 can be achieved hereby.

If the handle 1 also comprises a closing cylinder unit 20, the closing cylinder unit 20 can be moved from a pre-mounting position 3 into a final mounting position 4 by the movement of the control element 40 into the securing position 6. If the final mounting position 4 is reached, the latching elements 25 act with the counter-latching elements 48 of the control element 40, so that a locking position of the closing cylinder unit 20 is reached.

The above explanation of the embodiments describes the present invention exclusively in the context of examples. Of course, individual features of the embodiments, if technically feasible, can be combined freely with one another without departing from the context of the present invention.

### LIST OF REFERENCE NUMERALS

1 Handle
2 Door
3 Pre-mounting position
4 Final mounting position
5 Retaining position
6 Securing position
7 Mounting position
8 Operating position
10 Grip lever
11 Dome
12 Free end
20 Closing cylinder unit
21 Axle
22 Control geometry
23 Axle body
24 Level surface
25 Latching elements
30 Mounting carrier
31 Cavity
32 Wall
40 Control element
41 Connecting element, projection
42 Actuator
43 Ribs
44 Reception
45. 1 Securing side
45. 2 Securing side
45. 3 Actuation side
46 Reception region
46. 1 Inner region
46. 2 Edge region
47 Wall
48 Counter latching element
49 Retaining region
50 Counter locking means
51 Counter active surface
60 Activation element
61 Contact surface
62 Fastening zone
63 Axis
64 Fastening reception
65 Mass balance
80 Securing element
81 Locking means
82 Fastening region
83 Rotation axis
84 Side
85 Seal
86 Opening
87 Active surface
88 Reception

1. A handle for a motor vehicle, with a mounting carrier, which can be fastened on the inside of a door of the motor vehicle, a grip lever, which can be arranged on the outside of the door of the motor vehicle and which is fastened to the mounting carrier, wherein the mounting carrier has a control element which is operatively connected to a securing element which can be arranged on the outside of the door, wherein the control element can be moved from a retaining position into a securing position, whereby the distance between the securing element and the control element can be reduced, so that a reliable fixing of the mounting carrier on the door can be achieved.

2. The handle according to claim 1, wherein the securing element has a locking means, which extends into a counter locking means of the control element in the securing position.

3. The handle according to claim 1, wherein the securing element has a fastening region which acts on the mounting carrier.

4. The handle according to claim 3, wherein during a movement of the control element from the retaining position into the securing position, the securing element is pivotable about a rotation axis, in particular in that the rotation axis passes through the fastening region.

5. The handle according to claim 1, wherein the securing element has a seal on a side facing the control element.

6. The handle according to claim 2, wherein a locking means of the securing element has at least one active surface which, during the movement of the control element into the securing position, acts on a counter active surface of the control element, so that the locking means is pulled toward the counter locking means of the control element.

7. The handle according to claim 1, wherein the control element has an actuator, wherein, upon actuation of the actuator, a movement of the control element is effected from the retaining position into the securing position and/or vice versa.

8. The handle according to claim 7, wherein the actuator is located at least partially on the outside of the mounting carrier.

9. The handle according to claim 7, wherein the actuator can be operated manually.

10. The handle according to claim 7, wherein the actuator is a screw element which acts on the mounting carrier and on the control element.

11. The handle according to claim 1, wherein the mounting carrier is designed with a cavity in which the control element is inserted, wherein the cavity is designed so that the control element is movable within the cavity between the retaining position and the securing position.

12. The handle according to claim 1, wherein the control element has a rib on at least one of its sides, whereby a reliable guidance is effected during the movement of the control element on the mounting carrier.

13. The handle according to claim 1, wherein the control element is arranged within the mounting carrier in such a way that the control element can be moved linearly between the retaining position and the securing position.

14. The handle according to claim 1, wherein a movable activation element is arranged on the mounting carrier, wherein, in the retaining position, the control element engages the activation element, whereby the activation element is held in a mounting position to allow a simplified mounting of the grip lever, in the securing position, the control element is detached from the activation element.

15. The handle according to claim 14, wherein the control element has a retaining region which, in the retaining position of the control element, engages a contact surface of the activation element.

16. The handle according to claim 14, wherein the handle has a dome which is held in a fastening zone of the activation element.

17. The handle according to claim 16, a fastening region of the securing element is in contact with the dome.

18. The handle according to claim 1, wherein a closing cylinder unit is movably mounted on the mounting carrier, whereby the closing cylinder unit can be brought between a pre-mounting position and a final mounting position, wherein in particular the closing cylinder unit is mounted rotatably about an axis.

19. The handle according to claim 18, wherein in the retaining position of the control element, the closing cylinder unit is in the pre-mounting position and in the securing position of the control element, the closing cylinder unit is in the final mounting position.

20. The handle according to claim 18, wherein the closing cylinder unit has a control geometry on which the control element acts, in particular in that the control element has a connecting element, which is in operative connection with the control geometry.

21. The handle according to claim 18, wherein the control element has a reception in which the closing cylinder unit is arranged, and wherein the closing cylinder unit is partially enclosed by the control element.

22. The handle according to claim 18, wherein the control element (40) has two securing sides and one actuating side, wherein the actuating side connects both opposing securing sides and the closing cylinder unit is arranged between both securing sides.

23. The handle according to claim 18, wherein the control element has a reception region and the closing cylinder unit has an axle body through which the axis extends, wherein the axle body is arranged in the reception region, wherein in particular upon movement of the control element, the axle body moves relative within the reception region.

24. The handle according to claim 23, wherein the reception region has an inner region and an edge region, wherein the reception region is designed as an opening, which becomes smaller from the inner region to the edge region, wherein, in the retaining position of the control element, the axle body is located in the inner region and, in the securing position of the control element, the axle body is located in the edge region.

25. The handle according to claim 23, wherein the axle body is designed as a cylinder, wherein a lateral surface of the axle body has a level surface at least in regions, which, in the securing position of the control element, contacts a wall of the reception region.

26. The handle according to claim 18, wherein the closing cylinder unit has at least one latching element which, in the securing position of the control element, engages a counter latching element of the control element, wherein, in the retaining position of the control element-, the at least one latching element is detached from the counter latching element, wherein in particular the at least one latching element and/or the counter latching element is/are formed like a rib.

27. The handle according to claim 18, wherein the securing element has an opening for access to the closing cylinder unit, wherein in particular the control element is metallic.

28. The handle according to claim 1, wherein the securing element is designed to be closed, wherein in particular the control element is made of a plastic.

29. A method for mounting the handle according to claim 1 with a mounting carrier, which can be fastened on the inside of a door of the motor vehicle, a grip lever, which can be arranged on the outside of the door of the motor vehicle and which is fastened to the mounting carrier, wherein the mounting carrier has a control element which is operatively connected to a securing element which can be arranged on the outside of the door, wherein, upon movement of the control element from a retaining position into a securing position, the distance between the securing element and the control element is reduced, so that a reliable fixation of the mounting carrier on the door can be achieved.

30. The method according to claim 29, wherein a closing cylinder unit is in operative connection with the control element, wherein, upon movement of the control element into the securing position, the closing cylinder unit moves from a pre-mounting position to a final mounting position.

31. The method according to claim 29, wherein the mounting carrier has an activation element which is movably arranged on the mounting carrier, wherein, in the retaining position, the control element engages the activation element, whereby the activation element is held in a mounting position, in order to enable a simplified mounting of the grip lever on the activation element, via a movement of the control element into the securing position, the control element is detached from the activation element and at the same time an increased force is exerted on the mounting carrier, so that a fastening action of the mounting carrier to the inside of the door can be increased.
